(19) United States
(12) Patent Application Publication
(10) Pub. No.: US 2021/0314815 A1
(43) Pub. Date: Oct. 7, 2021

(54) Device And Method For Flexible Frame Compression

(71) Applicant: HUAWEI TECHNOLOGIES CO., LTD., Shenzhen (CN)

(72) Inventors: Sandip GANGAKHEDKAR, Munich (DE); Ali Ramadan ALI, Munich (DE); Karthikeyan GANESAN, Munich (DE)

(21) Appl. No.: 17/353,365

(22) Filed: Jun. 21, 2021

Related U.S. Application Data
(63) Continuation of application No. PCT/EP2018/086144, filed on Dec. 20, 2018.

(51) Int. Cl. H04W 28/06; H04L 29/06

(52) U.S. Cl. CPC H04W 28/06; H04L 69/04

(57) ABSTRACT

The disclosure proposes methods and device for supporting flexible frame compression. The method at transmit end comprises: obtaining an original frame; select at least one of a plurality of compression profiles based on one or more compression parameters including a compression context, wherein the compression context comprises mobile network information; compress the original frame based on the at least one selected compression profile to obtain a compressed frame; and transmitting the compressed frame, particularly to a wireless receiving device. Accordingly, the method at receive end comprise: receiving a compressed frame, particularly from a wireless transmitting device; obtaining at least one of a plurality of compression profiles based on one or more compression parameters including a compression context, wherein the compression context comprises mobile network information; and decompressing the compressed frame based on the at least one obtained compression profile to obtain an original frame.

### CROSS-REFERENCE TO RELATED APPLICATIONS

This application is a continuation of International Application No. PCT/EP2018/086144, filed on Dec. 20, 2018, the disclosure of which is hereby incorporated by reference in its entirety.

### TECHNICAL FIELD

The present disclosure relates to a compression method of Ethernet or link-layer frames, in particular, a flexible compression scheme for Ethernet-based protocols in 5G. In particular, the disclosure provides a wireless transmitting device and a wireless receiving device both for supporting frame compression.

### BACKGROUND

Industrial Ethernet protocols have stringent performance requirements for packet errors and latency that need to be supported over new radio (NR) for wireless Ethernet operation. These requirements often exceed the ultra-reliable low-latency communication (URLLC) requirements targeted in Rel-15 (3GPP TR 38.913 V15.0.0 (2018-06), Sec 7.5/7.9). One major problem for wireless Ethernet over 5G is the reduced system capacity (or number of wireless Ethernet links) due to the stringent requirements on latency and reliability of the underlying data traffic. Protocol compression is typically used to alleviate this problem by reducing the payload size of data sent over-the-air.

Several header compression protocols (profiles) have been defined by the Internet Engineering Task Force (IETF) for network protocols like Transmission Control Protocol (TCP), User Datagram Protocol (UDP), Real-time Transport Protocol (RTP), Internet Protocol (IP) etc., notably Robust Header Compression (RoHC) (RFC 3095) and ROHCv2 (RFC 5225). These compression protocols are supported to some extent in current 3^{rd} Generation Partnership Project (3GPP) networks. However, industrial Ethernet protocols have their own versions of frame formats and headers; similar compression schemes exist for some protocols, either in standardized or proprietary forms. Compression schemes for industrial Ethernet protocols are not yet natively supported in 3GPP networks.

The idea of carrying time-critical Ethernet-based and/or fieldbus protocols over 3GPP wireless networks has been proposed for the first time by 3GPP's SA1 WG in Release 15. In Release 16, several concrete use-cases and system requirements involving time-critical and seamless Ethernet-over-5G communication are discussed. 3GPP RAN2 WG has approved a Study Item in June 2015 for investigating URLLC enhancements for Industrial IoT, in particular “Ethernet header compression (with defining new RoHC Profile)”, among other topics.

However, there is currently no native or external support for header or data compression of Ethernet-based industrial automation protocols in 3GPP networks. Native support here refers to the ability to provide a 3GPP-defined or 3GPP-specific protocol compression scheme. External support refers to the ability to support an already standardized non-3GPP protocol compression scheme like RoHC. Note that external support for RoHC exists from Long Term Evolution (LTE) Release 8, but these schemes do not generally apply for Industrial Ethernet or fieldbus protocols that are, in many cases, non-IP based. Static fields of the Ethernet headers can he compressed relatively easy as it contains fields such as source and destination media access control (MAC) address, type of traffic which is not going to change for a period of time.

There are some commercially available solutions for Industrial Ethernet protocol compression that do not preclude the use of 3GPP networks. However, they are decoupled from the 3GPP network and do not consider compression aspects from wireless link delays, network topology, node mobility, signal-to-noise ratio (SNR) etc. of the 3GPP network, which impact the compression performance and the End-2-End (E2E) service reliability.

Protocol compression can be static or dynamic in nature: static compression is applied to fixed header fields whereas dynamic compression applies to varying header fields and/or payload data. Dynamic compression, in particular, may have several different compression levels or ratios (i.e. the ratio of compressed packet length to uncompressed packet length). The compression latency typically increases for higher compression levels as more processing is required. Hence a tradeoff exists between compression latency and system capacity, given the E2E service requirements.

The key technical problems addressed by the disclosure are summarized as follows:

High frame overhead for Industrial Ethernet protocols: Ethernet-based Industrial automation protocols contain a lot of header and control information that does not carry actual information. Transmitting such protocols over wireless links wastes costly resources, reducing the system capacity of the wireless network.

Support for compression of multiple Ethernet-based protocols/standards: How to support compression profiles for a variety of Industrial Ethernet protocols, some of which may be standardized and some non-standardized.

Support of varying compression levels: How to support various compression levels and switching between compression levels based on the tradeoff between compression latency and system capacity, given the E2E service requirements.

### SUMMARY

In view of the above-mentioned problems and disadvantages, the present disclosure aims to provide a method for dynamic compression ratio selection for Ethernet traffic that is based on new context information available in the 5G system. An objective is in particular to increase 5G system capacity by compressing or eliminating redundant or “compressible” information. Further, support should he provided for standardized and custom compression profiles to ensure compatibility to a wide range of Industrial Ethernet standards. Additionally, a flexible compression scheme should be provided that allows to tradeoff between compression levels and latency by flexibly selecting compression levels based on context information and Quality of Service (QoS) requirements.

The objective is achieved by the embodiment provided in the enclosed independent claims. Advantageous implementations of the embodiments of the present disclosure are further defined in the dependent claims.

A first aspect of the disclosure provides a wireless transmitting device for supporting frame compression, the wireless transmitting device being configured to: obtain an original frame; select at least one of a plurality of compression profiles based on one or more compression parameters including a compression context, wherein the compression context comprises mobile network information; compress the original frame based on the at least one selected compression profile to obtain a compressed frame; and transmit the compressed frame, particularly to a wireless receiving device.

The device of the first aspect is thus proposed to use a Generalized Compression Function (GCF) that compresses an incoming Ethernet frame based on at least one selected compression profiles. The compression profile specifies how the compression is performed and may be standardized (e.g. RFC 3095, RFC 5225 etc.). Accordingly, the device of the first aspect can provide a method for dynamic compression ratio selection for Ethernet traffic that is based on new context information available in the 5G system. In particular, the device of the first aspect can increase 5G system capacity by compressing or eliminating redundant or compressible information.

In an implementation form of the first aspect, the one or more compression parameters further comprises one or more of protocol identifiers, and/or a frame format descriptor.

The protocol identifier may identify the payload's protocol (e.g. EtherCAT, Profinet etc.) and allow the application of standardized header compression profiles, like RoHC (if available). The Header/Frame format descriptor may provide a schema describing the header/frame structure and may be used by the GCF to compress new, custom or non-standard protocols.

In an implementation form of the first aspect, the compression context comprises at least one of the following information:

a node address,

a topology specification,

a flow identifier,

a message correlation,

an E2E service requirement,

a compression level or a set of compression levels.

The compression context thus contains application-specific as well as 3GPP-network specific information that may be used by the GCF for compression.

In an implementation form of the first aspect, the wireless transmitting device is configured to obtain the compression context from a radio access network, RAN, node, and/or a core network, CN, node.

The compression context information may be distributed across different RAN and CN nodes in the 5G network. The RAN node may be a user equipment (UE), a BS or any other node in the Radio Access Network. The CN node is any node belonging to the Core network, including 3rd party application servers that interface via the Network Exposure Function (NEF) to the CN.

In an implementation form of the first aspect, the wireless transmitting device is configured to obtain the one or more protocol identifiers and/or a frame format descriptor from a RAN node, and/or a CN node.

In an implementation form of the first aspect, the wireless transmitting device is configured to compress a first field, in particular a static field, of the frame based on a first compression profile, in particular if a first indication indicates that the compression context is obtained by the wireless receiving device.

Once the compression context is stored at both the transmitter and receiver, and an acknowledgement (ACK) is received, a static compression may be performed. In this state, the static fields in the Ethernet header are compressed and the State bit in the Packet Data Convergence Protocol (PDCP) control protocol data unit (PDU) is set to “Ethernet header compression”.

In an implementation form of the first aspect, the wireless transmitting device is configured to compress a second field, in particular a dynamic field, of the frame based on a second compression profile and/or a compression level, in particular if a second indication indicates that the second compression profile and/or the compression level is obtained by the wireless receiving device.

In the static compression state, a transition to dynamic compression state can be triggered, which further compresses dynamic Ethernet headers and/or the payload.

In an implementation form of the first aspect, the wireless transmitting device is configured to transmit a third indication indicating a change in the selected compression profile and/or compression level, to the wireless receiving device.

The dynamic compression state may beneficially receive a constant feedback on the preferred/required compression ratio or compression profile between the transmitter and the receiver which may be signaled as part of the PDCP Control PDU.

A second aspect of the present disclosure provides a wireless receiving device for supporting frame compression, the wireless receiving device being configured to: receive a compressed frame, particularly from a wireless transmitting device; obtain at least one of a plurality of compression profiles based on one or more compression parameters including a compression context, wherein the compression context comprises mobile network information; and decompress the compressed frame based on the at least one obtained compression profile to obtain an original frame.

There exists an Inverse Generalized Compression Function (GCF⁻¹) at the receiving side that decompresses the compressed frame based on at least one obtained compression profiles. By performing substantially the inverse operation compared to the device of the first aspect, the wireless receiving device retrieves the original frame, and thereby supports a compression of multiple Ethernet-based protocols/standards.

In an implementation form of the second aspect, the one or more compression parameters further comprises one or more of protocol identifiers, and/or a frame format descriptor.

In an implementation form of the second aspect, the compression context comprises at least one of the following information:

a node address,

a topology specification,

a flow identifier,

a message correlation,

an E2E service requirement,

a compression level or a set of compression levels.

The compressed frame is decompressed based on parameters like the protocol identifier, frame format descriptor, compression profile and stored context. Signaling methods for sharing this information between the transmitter and receiver are one aspect of the disclosure and described in detail in the embodiments.

In an implementation form of the second aspect, the wireless receiving device is configured to obtain the compression context from a radio access network, RAN, node, and/or a core network, CN, node.

The RAN node may be a UE, a BS or any other node in the Radio Access Network. The CN node is any node belonging to the Core network, including 3rd party application servers that interface via the NEF to the CN.

In an implementation form of the second aspect, the wireless receiving device is configured to obtain the one or more protocol identifiers and/or a frame format descriptor from a RAN node, and/or a CN node.

In an implementation form of the second aspect, the wireless receiving device is configured to send a first indication indicating that the compression context is obtained by the wireless receiving device, particularly to the wireless transmitting device.

Once the compression context is stored at both transmitter and receiver and a first indication is sent by the wireless receiving device to the wireless transmitting device, a static compression is being performed. In this state, the static fields in the Ethernet header are compressed and the State bit in the PDCP control PDU is set to “Ethernet header compression”.

In an implementation form of the second aspect, the wireless receiving device is configured to send a second indication indicating that a second compression profile and/or the compression level is obtained by the wireless receiving device, particularly to the wireless transmitting device.

In the static compression state, a transition to dynamic compression state can be triggered, which further compresses dynamic Ethernet headers as well as the payload.

In an implementation form of the second aspect, the wireless transmitting device is configured to receive a third indication indicating a change in the obtained compression profile from the wireless transmitting device.

The dynamic compression state requires constant feedback on the preferred/required compression ratio or compression profile between the transmitter and the receiver which may be signaled as part of the PDCP Control PDU.

A third aspect of the present disclosure provides a method for supporting flexible frame compression, the method comprising: obtaining an original frame; selecting at least one of a plurality of compression profiles based on one or more compression parameters including a compression context, wherein the compression context comprises mobile network information; compressing the original frame based on the at least one selected compression profile to obtain a compressed frame; and transmitting the compressed frame, particularly to a wireless receiving device.

The method of the third aspect and its implementation forms provide the same advantages and effects as described above for the wireless transmitting device of the first aspect and its respective implementation forms.

A fourth aspect of the present disclosure provides a method for supporting flexible frame compression, the method comprising: receiving a compressed frame, particularly from a wireless transmitting device; obtaining at least one of a plurality of compression profiles based on one or more compression parameters including a compression context, wherein the compression context comprises mobile network information; and decompressing the compressed frame based on the at least one obtained compression profile to obtain an original frame.

The method of the fourth aspect and its implementation forms provide the same advantages and effects as described above for the wireless receiving device of the second aspect and its respective implementation forms.

It has to be noted that all devices, elements, units and means described in the present application could be implemented in the software or hardware elements or any kind of combination thereof. All steps which are performed by the various entities described in the present application as well as the functionalities described to he performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms of the present disclosure will be explained in the following description of specific embodiments in relation to the enclosed drawings, in which

FIG. 1 shows a wireless transmitting device according to an embodiment of the disclosure.

FIG. 2 shows a GCF performed by the transmitting device according to an embodiment of the present disclosure.

FIG. 3 shows an example of a wired-wireless network topology according to an embodiment of the present disclosure.

FIG. 4 shows an example of topology specification as Adjacency matrix according to an embodiment of the present disclosure.

FIG. 5 shows an example of exploiting message correlations for compression according to an embodiment of the present disclosure.

FIG. 6 shows an example of flexible compression level selection based on QoS requirements and Channel capacity according to an embodiment of the present disclosure.

FIG. 7 shows an example of signaling of context information to GCF according to an embodiment of the present disclosure.

FIG. 8 shows an example of compression context for Ethernet-5G bridging according to an embodiment of the present disclosure.

FIG. 9 shows an example of compression state diagram for Ethernet according to an embodiment of the present disclosure.

FIG. 10 shows an example of proposed PDCP control PDU structure according to an embodiment of the present disclosure.

FIG. 11 shows an example of 5G-Ethernet Ring topology according to an embodiment of the present disclosure.

FIG. 12 shows an example of signaling for dynamic compression ratio selection with NR Uu according to an embodiment of the present disclosure.

FIG. 13 shows an example of signaling enhancement considering D2D according to an embodiment of the present disclosure.

FIG. 14 shows a wireless receiving device according to an embodiment of the disclosure.

FIG. 15 shows a schematic block flowchart of a method for supporting flexible frame compression according to an embodiment of the present disclosure.

FIG. 16 shows a schematic block flowchart of another method for supporting flexible frame compression according to an embodiment of the present disclosure.

### DETAILED DESCRIPTION OF EMBODIMENTS

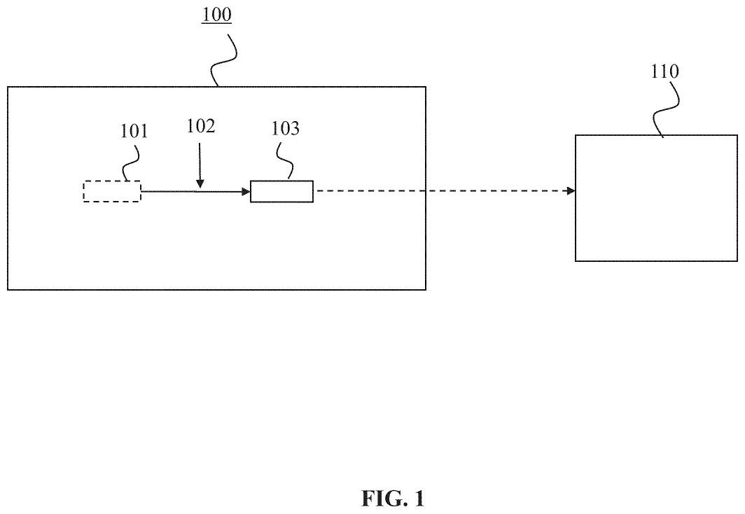

FIG. 1 shows a wireless transmitting device 100 according to an embodiment of the disclosure. The wireless transmitting device 100 is configured to: obtain an original frame 101; select at least one of a plurality of compression profiles 102 based on one or more compression parameters including a compression context, wherein the compression context comprises mobile network information; compress the original frame 101 based on the at least one selected compression profile 102 to obtain a compressed frame 103; and transmit the compressed frame 103, particularly to a wireless receiving device 110.

The wireless transmission device 100 can be a UE, a RAN, or a system comprising a RAN device and a CN device. For example, the compression can he done in the CN device and the RAN performs the wireless transmission to the wireless receiving device, which can be an UE or a relay device, e.g. another RAN node, etc.

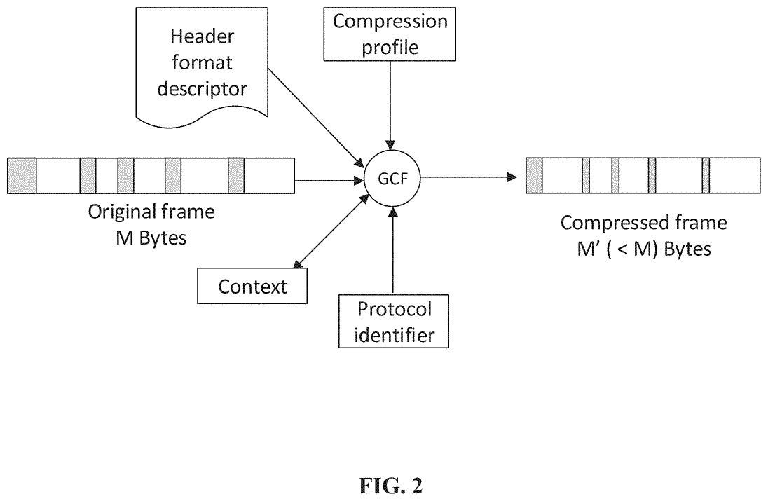

The present disclosure proposes a Generalized Compression Function (GCF) that compresses an incoming Ethernet frame according to one of more of the protocol identifier, header/frame format descriptor, compression profile and stored context. As shown in FIG. 2, an M bytes original frame is compressed using GCF, and an M′ bytes compressed frame is obtained after the compression process, wherein M and M′ are both positive numbers, and M′<M.

The one or more compression parameters further comprises one or more protocol identifiers, and/or a frame formal descriptor. In particular, the protocol identifier may identify the frame's protocol (e.g. EtherCAT, Profinet etc.) and may allow the application of standardized header compression profiles like RoHC (if available). The header/frame format descriptor may provide a schema describing the header/frame structure and is used by the GCF to compress new, custom or non-standard protocols and/or payload data.

The Compression context (or simply context) contains application-specific as well as 3GPP-network specific information that is used by the GCF for compression.

For instance, the Compression context may consist of the following information in Table 1 belonging to the application (i.e. Ethernet-based protocol) as well as the wireless network:

TABLE 1
Compression context

| Application | Network |
|---|---|
| Node addresses in the wired | Node address in 3GPP network |
| network (ex. EtherCAT Node ID) | (ex. C-RNTI, Subscriber |
| | identity, etc,) |

Topology specification (connectivity/adjacency matrix)

| | |
|---|---|
| Protocol Identifier (ex. | Flow identifiers in 3GPP network |
| PROFINET, EtherCAT, etc.) | (QoS Flow IDs, PDU Session |
| | Identifier etc.) |
| Flow identifiers in wired | Available/Monitored E2E QoS |
| network (ex. Stream IDs, | |
| VLAN Tags etc.) | |
| Message correlations | RAN parameters |
| E2E service requirements | Mesh, star, ring topology with |
| | Uu, PC5, both Uu, PC5 |
| E2E link connectivity | |

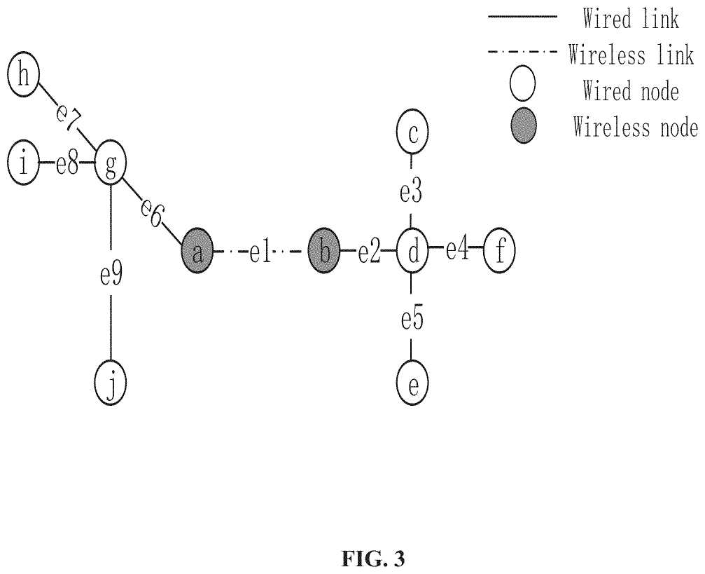

Note that addresses, flow identifiers and topology information are used by the GCF to compress standardized node addresses and flow identifiers. Consider the network topology in FIG. 3, which depicts a subset of a future industrial factory network: Nodes a and b (with corresponding network addresses ‘a’ and ‘b’) are 3GPP devices (i.e. UEs, RAN nodes or CN nodes) and the remaining nodes are devices belonging to the wired Ethernet or fieldbus network. Edge e1 refers to a wireless link, either the Uu or PC5 link in 3GPP parlance. Uu refers to an interface between UEs and a Node for example a gNB, and PC5 refers to an interface between two UEs. The remaining edges e2 . . . e7 are wired links.

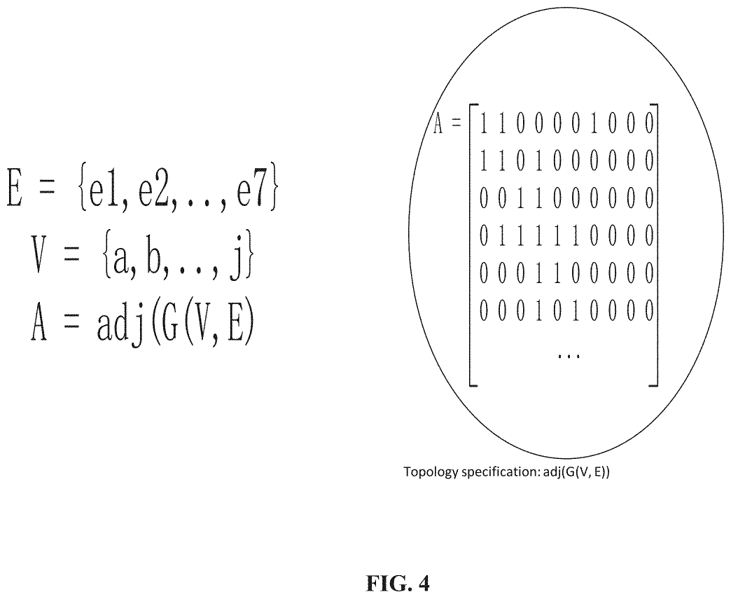

The depicted network according to FIG. 3 can be represented as a connected graph G (V, E), where V is a set of vertices (nodes) and E is a set of edges in the network. G's adjacency matrix, A=adj (G (V, E)) is shown in FIG. 4.

Protocol identifiers refer to unique identifiers for Ethernet-based protocols like PROFINET, EtherCAT etc. that correspond to EtherType field from the Ethernet packet, which inform the GCF to process the incoming frame. Protocol identifiers max also refer uniquely to non-Ethernet based protocols that are carried over the 5G network.

A flow identifier refers to the QoS flow identifier (QFI), which belongs to a PDU Session and represents the end-to-end QoS characteristics of that traffic flow in the 5G network.

Message correlations can be provided to the compressing entity as part of the compression context and they describe the level of correlation between data packets. Message correlations provide an additional input to select suitable compression levels at the GCF. For instance, the keep alive packets exchanged between a Power Line Communication (PLC) master and slave(s) are highly correlated and contain a lot of redundant payload bits for which dynamic payload compression could be applied if the GCF is aware of the message correlations.

E2E link connectivity refers to the type of topology supported between PLC master and PLC slaves and could be an input parameter to RAN to determine the level of compression required.

Industrial Ethernet protocols have length message identifier fields that imply a finite number of message types. Correlations between messages of different types can be exploited to compress the message identifier field in the original header.

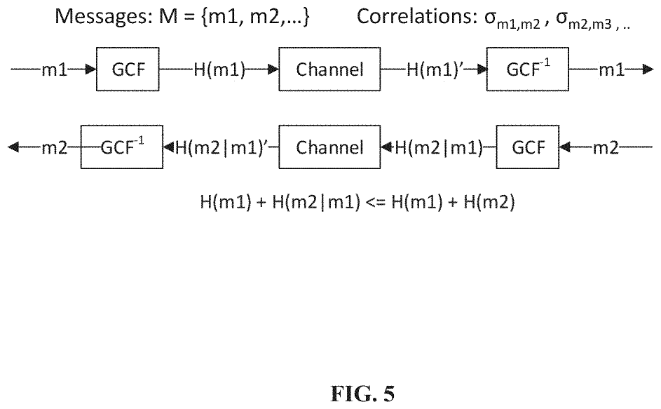

As shown in FIG. 5, messages belong to a finite set M={m1, m2, . . . } and have correlations σ_{m1,m2}, σ_{m2,m3} which may be known a-priori or learnt over time. A message m1 is compressed to H(m1) bits by the GCF, before passing through a lossy channel and received as H(m1)′ bits at the Inverse GCF which decompresses and recovers the original message m1. H(.) is the information entropy. Depending on σ_{m1,m2}, reception of m1 triggers message m2 in the reverse direction. Knowledge of the conditional probability of m2 given m1 allows the GCF to compress m2 into H(m2|m1) bits, which is not higher than H(m2), leading to better compression performance.

E2E service requirements are specified by the wired network in the form of QoS requirements like maximum latency, packet loss rate, bandwidth etc., and are expected to be fulfilled by the 5G system (5GS). The 5GS internally monitors the QoS on different links (ex. Uu/PC5N3/etc.) and is included as part of the context. RAN parameters like SNR, RSRP, RSSI, CSI, mobility indicator may also be stored as part of the compression context. Together, this information allows the GCF to select a compression level based on the underlying radio-network conditions, the monitored QoS performance and the E2E service requirements.

It should be noted that there is a practical tradeoff between compression performance and latency: higher the level of compression, greater is the compression latency. The GCF considers flexible compression levels based on the channel conditions on the different links (i.e. RAN parameters), the QoS requirements for each message/flow, and the available resources (for instance: bandwidth).

For example, a link with lower capacity requires high compression level which allows for lower coding rate and hence more reliability. In another example, a message with lower latency requirements requires lower compression level if link capacity is sufficient.

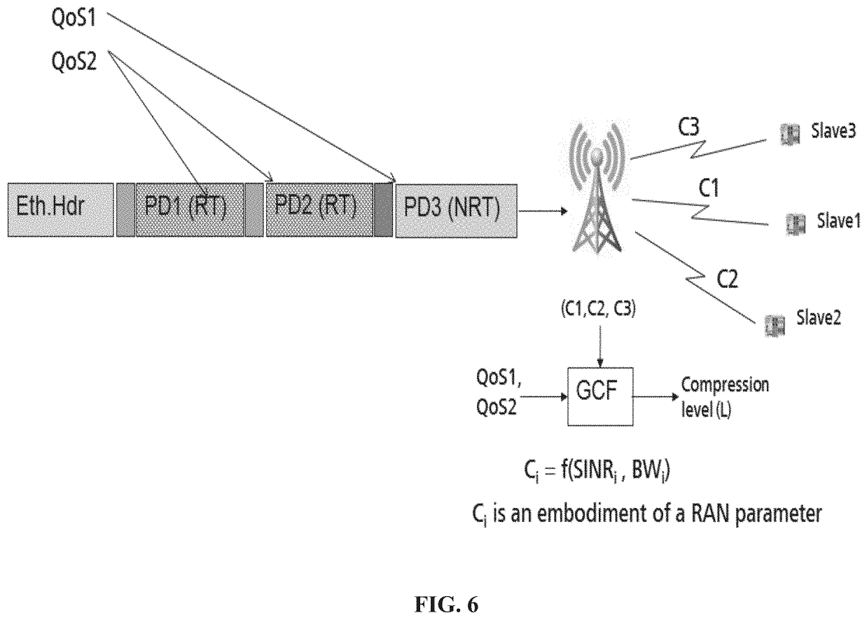

FIG. 6 provides an example of flexible compression level selection based on the Channel capacity (C) and the required QoS for data belonging to different nodes but packed in the same Ethernet frame. QoS1 and QoS2 refer to QoS requirements for Slaves 1 and 2 respectively. PD1, PD2 and PD3 refers to the packet data for Slaves 1, 2 and 3 respectively. RT refers to real-time data and NRT refers to non-real time data. The Channel capacity between the BS and the Slave i is denoted by Ci and is a function of the signal to interference and noise ratio (SINR) and the bandwidth. The compression level Lᵢ for UE i changes based on the channel conditions of the different links, the QoS requirements for each message, and the available resources (e.g. bandwidth). For example, for C₁>C₂, the GCF may select L₁<L₂.

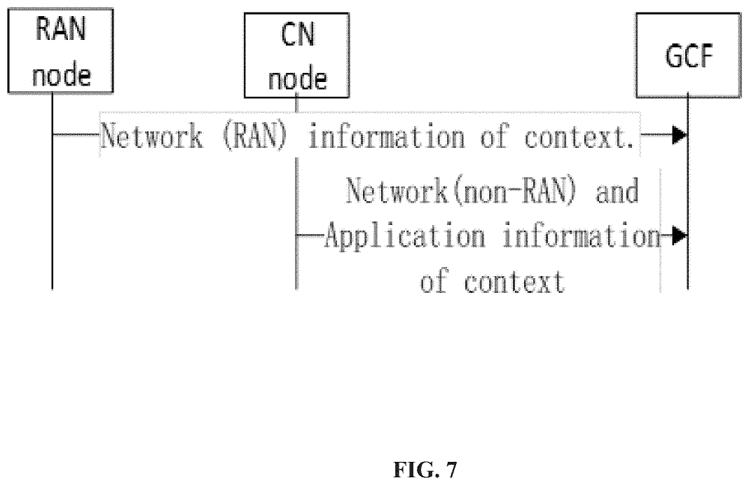

The wireless transmitting device 100 may be configured to obtain the compression context from a RAN node, and/or a CN node. The wireless transmitting device 100 may be further configured to obtain the one or more protocol identifiers and/or a frame format descriptor from a RAN node, and/or a CN node. In another word, the compression context information from Table 1 may be distributed across different RAN and CN nodes in the 5G network. This information is signaled to the GCF to allow for the aforementioned compression methods, as shown in FIG. 7. The RAN node may be a UE, a BS or any other node in the RAN. The CN node is any node belonging to the Core network, including 3rd party application servers that interface via the NEF to the CN.

The GCF may be located in a RAN node (e.g. 5G NodeB (gNB) or UE) or in a CN node (e.g. an application function (AF)) or both. The decision to locate the GCF in the RAN or CN may be static i.e. defined once and fixed for the gNB or the network. Alternatively, the GCF can be dynamically allocated to a RAN or CN node for different UEs or for the same UE over time, based on the compression context.

The proposed compression scheme and GCF can be applied for the cellular link as well as the sidelink. In particular, the cellular link refers to uplink or downlink communication between UEs and a base station, and the sidelink refers to a direct communication mechanism between device and device without going through eNB.

### Embodiment 1: Compression Context for Ethernet-5G Bridging

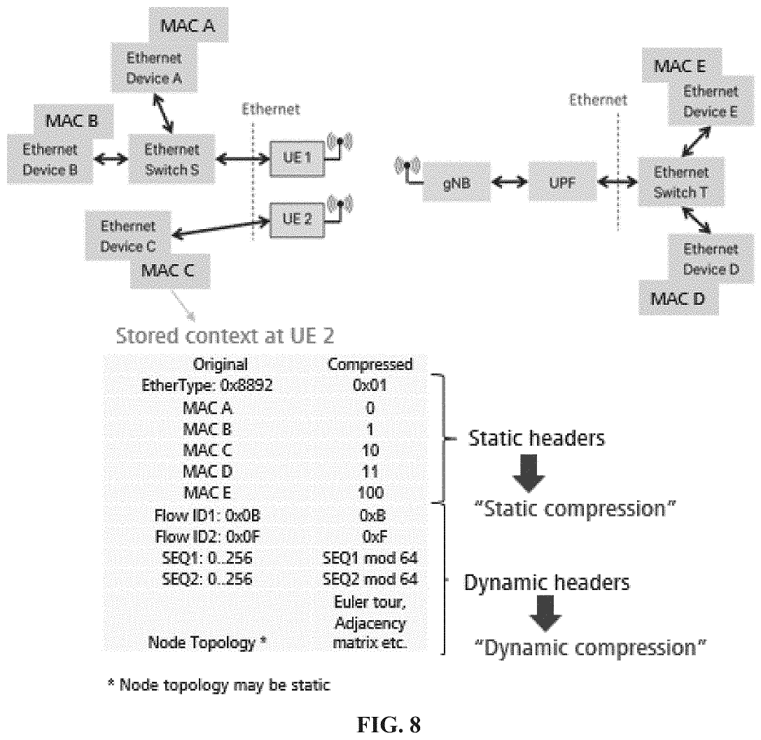

A 5G-Ethernet bridge network is shown in FIG. 8. Two UEs are connected to a gNB over the 5G Uu link. Both UEs and the SGC (i.e. User Plane Function (UPF)) are also connected to Ethernet switches or devices. Each UE maintains a compression context containing static header information like protocol identifiers, node addresses, topology etc. and dynamic header information like flow identifiers (e.g. VLAN tag), sequence numbers etc. of the Ethernet devices that are part of its context (source/destination/intermediate nodes).

The compression context can he shared between UEs and BS or between UEs, during PDU session establishment, bearer setup, pre-configuration phase etc.

### Embodiment 2: State Diagram Showing Transition to Different Compression States

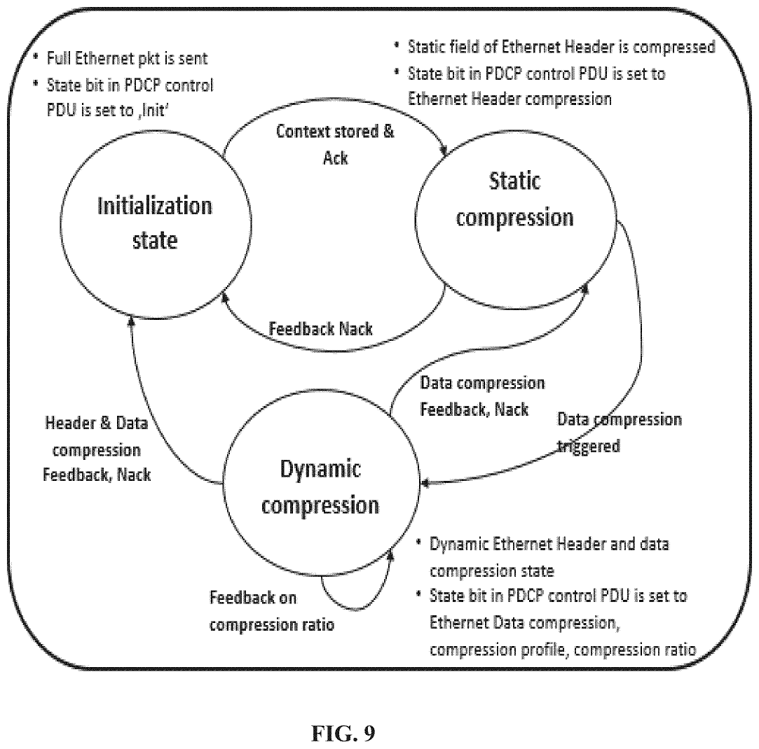

In FIG. 9, a dynamic compression ratio selection scheme for Ethernet traffic is shown as a State diagram.

According to this embodiment, the wireless transmitting device 100 may be configured to compress a first field, in particular a static field, of the frame based on a first compression profile, in particular if a first indication indicates that the compression context is obtained by the wireless receiving device 110.

In the Initialization state, the full Ethernet packet including the header is sent uncompressed with a prior indication in that a ‘State’ bit in the PDCP control PDU is set to “Init”. Once the compression context is stored at both the transmitter and the receiver and an ‘ACK’ is received, the state transitions to Static compression. In this state, the static fields in the Ethernet header are compressed and the ‘State’ bit in the PDCP control PDU is set to “Ethernet header compression”. A NACK received in this state causes a transition back to the Initialization state.

The wireless transmitting device 100 may be further configured to compress a second field, in particular a dynamic field, of the frame based on a second compression profile and/or a compression level, in particular if a second indication indicates that the second compression profile and/or the compression level is obtained by the wireless receiving device 110.

In the Static compression state, a transition to Dynamic compression state can be triggered, which further compresses dynamic Ethernet headers as well as the payload. This state requires constant feedback on the preferred/required compression ratio or compression profile between the transmitter and the receiver which may be signaled as part of the PDCP Control PDU. The Wireless transmitting device 100 is configured to: transmit a third indication indicating a change in the selected compression profile to the wireless receiving device. While in the Dynamic compression state, a transition to Static compression or Initialization state may be triggered by a NACK or by the implemented algorithm.

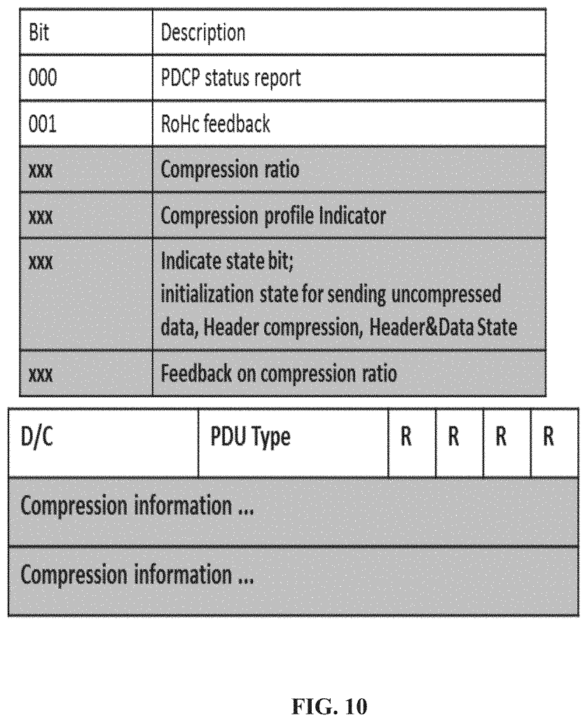

The new PDCP Control PDU fields for Ethernet compression is shown in FIG. 10 with the new fields highlighted in Bold/Grey. Further reference on PDCP control PDU can be found in 3GPP TS 38.323.

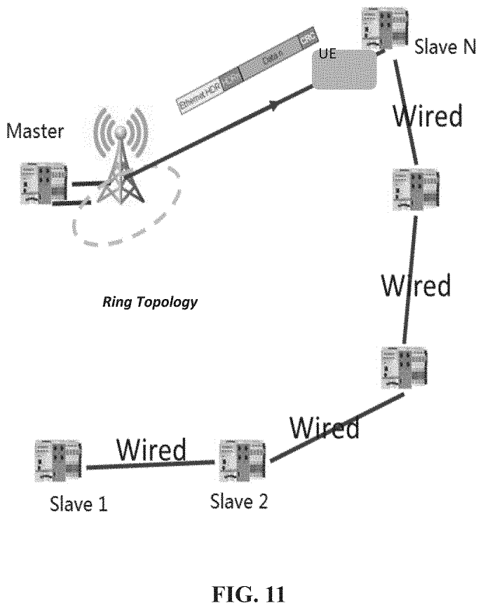

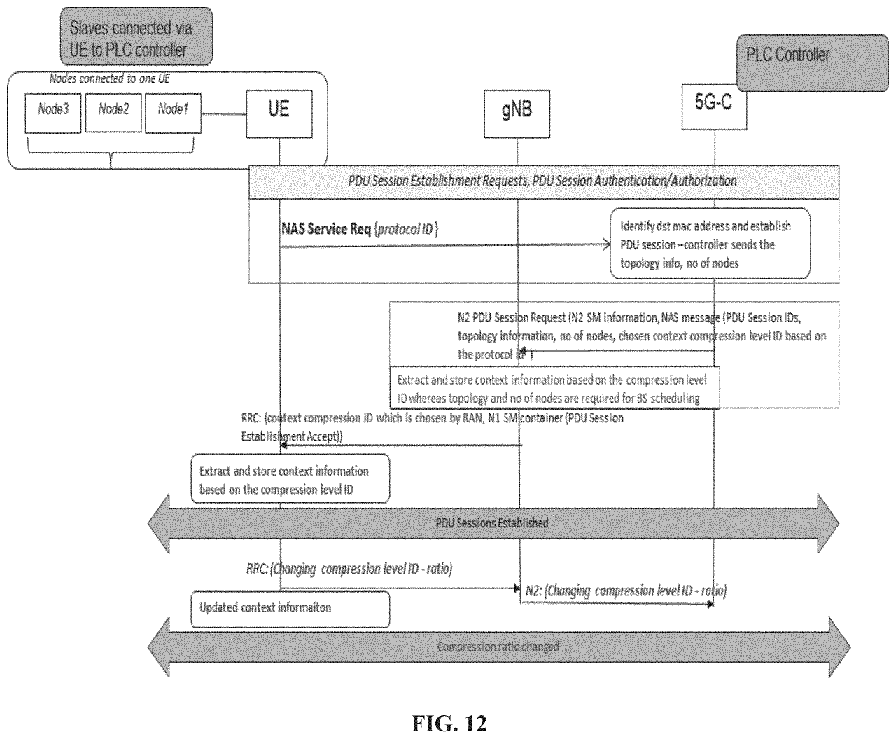

As shown in FIG. 11, PLC master is connected to 5G core network and the slaves are connected to a UE in a wired interface. To enable compression over the air interface, additional signaling enhancement between 5G core and gNB, gNB and UE are described in FIG. 12. The detailed 5G signaling to achieve dynamic compression ratio selection for FIG. 12 is shown below: where the following information is exchanged:

| NAS service request: UE → 5GC | Protocol id |
|---|---|
| N2 PDU session request: SMF → gNB | Topology information, no of |
| | nodes, compression level Id |
| RRC: gNB → UE, UE → gNB | Compression id updates |

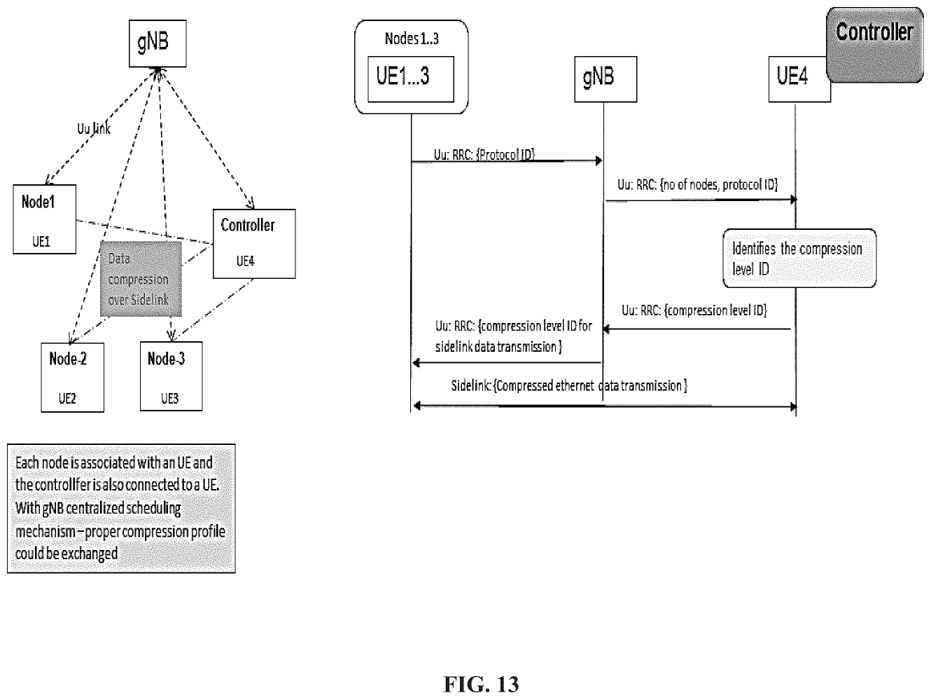

As shown in FIG. 13, PLC master is connected to a UE and the slaves are connected to a set of UEs. To enable compression over the air interface additional signaling enhancement between gNB and UE are described in FIG. 13, where the following information is exchanged:

| | |
|---|---|
| RRC: UE → gNB | Protocol id |
| gNB → UE | No of nodes, protocol id |
| UE to gNB | Compression level id |

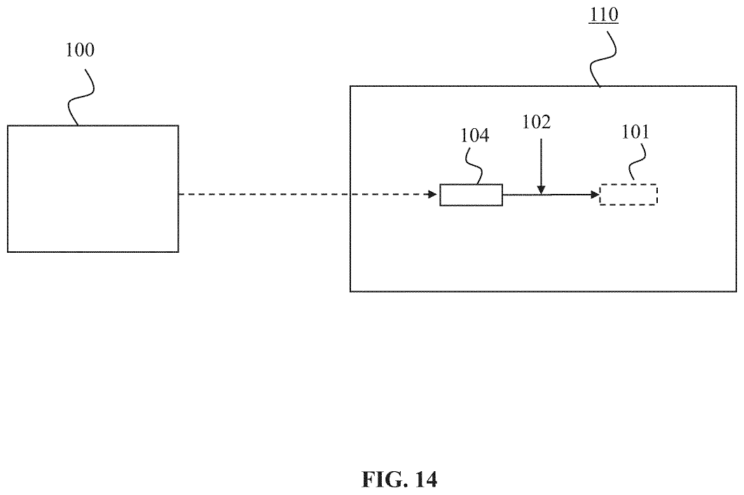

FIG. 14 shows a wireless receiving device 110 according to an embodiment of the disclosure. The wireless receiving device 110 is configured to support frame compression in 5G. The wireless receiving device 110 of FIG. 14 is particularly the receiving device 110 of FIG. 1. The wireless transmitting device 100 shown in FIG. 14 may be the one shown in FIG. 1. The wireless receiving device 110 may be a received or may be included in a receiver.

The wireless receiving device 110 may be configured to operate inversely to the transmitting device 100 of FIG. 1. In particular, the wireless receiving device 110 is configured to: receive a compressed frame 103, particularly from a wireless transmitting device 100; obtain at least one of a plurality of compression profiles 102 based on one or more compression parameters including a compression context, wherein the compression context comprises mobile network information; and decompress the compressed frame 103 based on the at least one obtained compression profile to obtain an original frame 101.

An Inverse Generalized Compression Function (GCF⁻¹) is implemented at the receiving side that decompresses the compressed frame based on the protocol identifier, frame format descriptor, compression profile and stored context.

The one or more compression parameters may further comprise one or more of protocol identifiers, and/or a frame format descriptor. The protocol identifiers and the frame format descriptor are similar as defined with the wireless transmitting device.

The Compression context (or simply context) contains application-specific as well as 3GPP-network specific information that is used by the GCF⁻¹ for decompression. Specifically, the Compression context consists of information from Table 1.

Signaling methods for sharing this information between the transmitter and receiver are described above. In particular, the wireless receiving device 110 may be configured to obtain the compression context information from a RAN node, and/or a CN node. In addition, the wireless receiving device 110 may be also configured to obtain the one or more protocol identifiers and/or a frame format descriptor from a RAN node, and/or a CN node.

The wireless receiving device 110 is further configured to send a first indication indicating that the compression context is obtained by the wireless receiving device 110, particularly to the wireless transmitting device 100.

The wireless receiving device 110 is further configured to send a second indication indicating that a second compression profile and/or the compression level is obtained by the wireless receiving device, particularly to the wireless transmitting device.

The wireless receiving device 110 is further configured to receive a third indication indicating a change in the obtained compression profile from the wireless transmitting device.

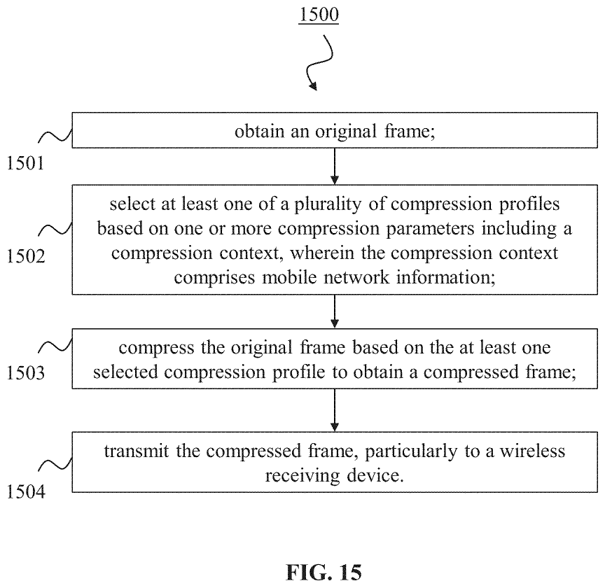

FIG. 15 shows a method 1500 for supporting flexible frame compression according to an embodiment of the present disclosure. In particular, the method 1500 is performed by a wireless transmitting device. The method 1500 comprises: a step 1501 of obtaining an original frame; a step 1502 of selecting at least one of a plurality of compression profiles based on one or more compression parameters including a compression context, wherein the compression context comprises mobile network information; a step 1503 of compressing the original frame based on the at least one selected compression profile to obtain a compressed frame; and a step 1504 of transmitting the compressed frame, particularly to a wireless receiving device.

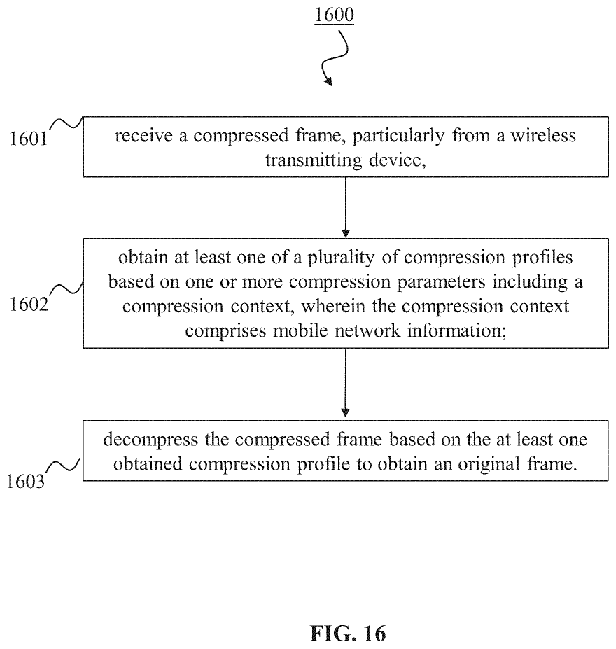

FIG. 16 shows a method 1600 for supporting flexible frame compression according to an embodiment of the present disclosure. In particular, the method 1600 is performed by a wireless receiving device. The method 1600 comprises: a step 1601 of receiving a compressed frame, particularly from a wireless transmitting device, a step 1602 of obtaining at least one of a plurality of compression profiles based on one or more compression parameters including a compression context, wherein the compression context comprises mobile network information; arid a step 1603 of decompressing the compressed frame based on the at least one obtained compression profile to obtain an original frame.

In summary, embodiments of the present disclosure achieve multiple benefits. Advantages are summarized as:

Optimizing system capacity: Increase 5G system capacity by compressing or eliminating redundant or “compressible” information (headers and/or payload) taking into account all relevant network and application context information.

Generalized compression solution: Support for standardized and custom compression profiles to ensure compatibility to wide-range of Industrial Ethernet standards.

Flexibility: Flexible compression scheme that allows to tradeoff between compression levels and latency by flexibly selecting compression levels based on context information and QoS requirements.

The present disclosure has been described in conjunction with various embodiments as examples as well as implementations. However, other variations can be understood and effected by those persons skilled in the art and practicing the claimed disclosure, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

List of Abbreviations

| | |
|---|---|
| AF | Application Function |
| CN | Core Network |
| C-RNTI | Cell-Radio Network Temporary Identifier |
| gNB | 5G NodeB (Base Station) |
| E2E | End-to-End |
| MAC | Medium Access Control |
| NAS | Non Access Stratum |
| NEF | Network Exposure Function |
| PDU | Protocol Data Unit |
| PLC | Power Line Communication |
| QoS | Quality of Service |
| RoHC | Robust Header Compression |
| RRC | Radio Resource Control |
| RTP | Real Time Transport Protocol |
| SNR | Signal to Noise Ratio |
| SINR | Signal to Interference and Noise Ratio |
| UDP | User Datagram Protocol |
| UE | User Equipment |
| UPF | User Plane Function |
| VLAN | Virtual Local Area Network |

1. A method for supporting frame compression, the method comprising:
obtaining an original frame;
selecting at least one of a plurality of compression profiles based on one or more compression parameters including a compression context, wherein the compression context comprises mobile network information;
compressing the original frame based on the at least one selected compression profile to obtain a compressed frame; and
transmitting the compressed frame to a wireless receiving device.

2. The method according to claim 1, wherein:
the one or more compression parameters further comprise at least one of one or more protocol identifiers or a frame format descriptor.

3. The method according to claim 1, wherein:
the compression context comprises at least one of the following information:
a node address,
a topology specification,
a flow identifier,
a message correlation,
an E2E service requirement, or
a compression level or a set of compression levels.

4. The method according to the claim 1, comprising:
obtaining the compression context from at least one of a radio access network (RAN) node or a core network (CN) node.

5. The method according to the claim 2, comprising:
obtaining the at least one of the one or more protocol identifiers or the frame format descriptor from at least one of a RAN node or a CN node.

6. The method according to the claim 1, comprising:
compressing a first field, comprising a static field, of the original frame based on a first compression profile, in response to a first indication indicating that the compression context is obtained by the wireless receiving device.

7. The method according to claim 1, comprising:
compressing a second field, comprising a dynamic field, of the original frame based on at least one of a second compression profile or a compression level, in response to a second indication indicating that the at least one of the second compression profile or the compression level is obtained by the wireless receiving device.

8. The method according to claim 1, comprising:
transmitting a third indication indicating a change in at least one of the selected compression profile or compression level to the wireless receiving device.

9. A method for supporting frame compression, the method comprising:
receiving a compressed frame from a wireless transmitting device;
obtaining at least one of a plurality of compression profiles based on one or more compression parameters including a compression context, wherein the compression context comprises mobile network information; and
decompressing the compressed frame based on the at least one obtained compression profile to obtain an original frame.

10. The method according to claim 9, wherein:
the one or more compression parameters further comprises at least one of one or more protocol identifiers or a frame format descriptor.

11. The method according to claim 9, wherein:
the compression context comprises at least one of the following information:
a node addresses,
a topology specification,
a flow identifier,
a message correlation,
an E2E service requirement, or
a compression level or a set of compression levels.

12. The method according to claim 9, comprising:
obtaining the compression information from at least one of a radio access network (RAN) node or a core network (CN) node.

13. The method according to claim 10, comprising:
obtaining the at least one of the one or more protocol identifiers or the frame format descriptor from at least one of a RAN node or a CN node.

14. The method according to claim 9, comprising:
sending a first indication indicating that the compression context is obtained by a wireless receiving device to the wireless transmitting device.

15. The method according to claim 9, comprising:
sending a second indication indicating that at least one of a second compression profile or a compression level is obtained by a wireless receiving device to the wireless transmitting device.

16. The method according to claim 9, comprising:
receiving a third indication indicating a change in the at least one obtained compression profile from the wireless transmitting device.

17. A wireless transmitting device for supporting flexible frame compression, the wireless transmitting device comprising: at least one memory storing instructions and at least one processor coupled to the memory to execute the instructions to:
obtain an original frame;
select at least one of a plurality of compression profiles based on one or more compression parameters including a compression context, wherein the compression context comprises mobile network information;
compress the original frame based on the at least one selected compression profile to obtain a compressed frame; and
transmit the compressed frame to a wireless receiving device.

18. The wireless transmitting device according to claim 17, wherein:
the one or more compression parameters further comprises at least one of one or more protocol identifiers or a frame format descriptor.

19. The wireless transmitting device according to claim 17, wherein:
the compression context comprises at least one of the following information:
a node address,
a topology specification,
a flow identifier,
a message correlation,
an E2E service requirement, or
a compression level or a set of compression levels.

20. The wireless transmitting device according to claim 17, wherein the at least one processor execute the instructions to:
compress a first field, comprising a static field, of the original frame based on a first compression profile, in response to a first indication indicating that the compression context is obtained by the wireless receiving device.
